(19) United States
(12) Patent Application Publication
(10) Pub. No.: US 2025/0053250 A1
(43) Pub. Date: Feb. 13, 2025

(54) INFORMATION PROCESSING SYSTEM

(71) Applicant: Lenovo (Singapore) Pte. Ltd., Singapore (SG)

(72) Inventors: Keiichi Yoshitomi, Kanagawa (JP); Mitsuhiro Yamazaki, Kanagawa (JP); Yoshitsugu Suzuki, Kanagawa (JP)

(73) Assignee: Lenovo (Singapore) Pte. Ltd., Singapore (SG)

(21) Appl. No.: 18/797,120

(22) Filed: Aug. 7, 2024

(30) Foreign Application Priority Data
Aug. 7, 2023 (JP) 2023-128506

(51) Int. Cl. G06F 3/0354; G06F 3/01

(52) U.S. Cl. CPC G06F 3/03545; G06F 3/016

(57) ABSTRACT

An information processing system is configured by including a coordinates detector which is configured to detect coordinates which correspond to a position of an operational object surface with which a pen-shaped input device is in contact and a controller which is configured to so control as to switch ON/OFF of vibrations which are generated from the pen-shaped input device in accordance with an interval pattern which is obtained by sectionalizing a moving locus of the coordinates which are detected by the coordinates detector in a case where the pen-shaped input device moves in contact with the operational object surface in accordance with a predetermined distance.

### CROSS-REFERENCE TO RELATED APPLICATIONS

This application claims priority to Japanese Patent Application No. 2023-128506 filed on Aug. 7, 2023, the contents of which are hereby incorporated herein by reference in their entirety.

### BACKGROUND

### Technical Field

The present invention relates to an information processing system.

### Description of Related Art

In inputting into an interactive-type display system, it is known to use a pen-like stylus (a pen-shaped input device) which makes haptic sense feedback possible by generating vibrations by driving a haptic sense actuator as an input device.
Patent Document 1
Japanese Patent Application Publication No. 2017-537395

Since the pen-shaped input device vibrates and thereby it becomes possible to simulatively obtain the touch sense which is felt when sliding the nib on a writing medium such as paper, for example, it becomes possible for a user who is performing an inputting operation by using the pen-shaped input device to obtain a sense which is close to the touch sense which is obtained when performing a writing operation by using a real writing utensil.

In a case where it becomes possible to bring about usefulness to the user by configuring the pen-shaped input device so as to generate vibrations other than making the user feel a touch sense of performing a writing operation by using the real writing utensil, convenience and so forth of the user are improved.

Accordingly, the present invention aims to make it possible to give the usability to the user by utilizing the vibrations of the pen-shaped input device.

### SUMMARY

According to one aspect of the present invention which attains the above-described object, there is provided an information processing system which includes a coordinates detection unit (i.e., a coordinates detector) which is configured to detect coordinates which correspond to a position of an operational object surface with which a pen-shaped input device is in contact and a vibration control unit (or a vibration control section, i.e., a controller) which is configured to so control as to switch ON/OFF of vibrations which are generated from the pen-shaped input device in accordance with an interval pattern which is obtained by sectionalizing a moving locus of the coordinates which are detected by the coordinates detection unit in a case where the pen-shaped input device moves in contact with the operational object surface in accordance with a predetermined distance.

According to another aspect of the present invention, there is provided an information processing system which includes a coordinates detection unit which is configured to detect coordinates which correspond to a position of an operational object surface with which a pen-shaped input device is in contact and a vibration control unit which is configured to make the pen-shaped input device generate first-order vibrations at a timing that a shifting state of the coordinates which are detected meets a predetermined condition in a case where the pen-shaped input device moves in contact with the operational object surface on the basis of a detection status of the coordinates which are detected by the coordinates detection unit.

According to a further another aspect of the present invention, there is provided an information processing system which includes a coordinates detection unit which is configured to detect coordinates which correspond to a position of an operational object surface with which a pen-shaped input device is in contact and a vibration control unit which is configured to change the intensity of vibrations which are generated from the pen-shaped input device on the basis of a state of coordinates which are detected by the coordinates detection unit relative to predetermined reference coordinates in a case where the pen-shaped input device moves in contact with the operational object surface.

According to the present invention, it is possible to obtain such an effect that it becomes possible to bring about usefulness to a user by utilizing the vibrations of the pen-shaped input device.

### THE DESCRIPTION OF THE DRAWINGS

FIG. 1 is a diagram illustrating one example of an external configuration of an information processing system in the first embodiment.

FIG. 2 is a diagram illustrating examples of functional configurations of an information processing device and a pen-shaped input device which accord with vibration control in the first embodiment.

FIG. 3 is a diagram explaining an aspect example of vibration control in the first embodiment.

FIG. 4 is flowcharts illustrating examples of processing procedures that the information processing and the pen-shaped input device in the first embodiment execute correspondingly to vibration control.

FIG. 5 is a diagram explaining one example of vibration control in the first application example of the second embodiment.

FIG. 6 is a diagram explaining one example of the vibration control in the first application example of the second embodiment.

FIG. 7 is a diagram explaining one example of vibration control in the second application example of the second embodiment.

FIG. 8 is flowcharts illustrating examples of processing procedures that the information processing device and the pen-shaped input device execute correspondingly to vibration control in the second application example of the second embodiment.

FIG. 9 is a diagram explaining one example of vibration control in the third application example of the second embodiment.

FIG. 10 is a diagram explaining one example of vibration control in the first application example of the third embodiment.

FIG. 11 is a diagram explaining one example of vibration control in the second application example of the third embodiment.

FIG. 12 is a diagram explaining one example of a method of judging a coordinates movement direction in the second application example of the third embodiment.

FIG. 13 is a diagram explaining another example of the method of judging the coordinates movement direction in the second application example of the third embodiment.

FIG. 14 is flowcharts illustrating examples of processing procedures that the information processing device and pen-shaped input device execute correspondingly to vibration control in the second application example of the third embodiment.

### DETAILED DESCRIPTION

### First Embodiment

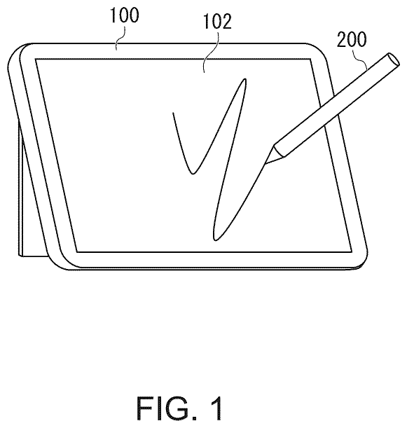

FIG. 1 illustrates one example of an external configuration of an information processing system according to the first embodiment. As illustrated in FIG. 1, the information processing system according to the first embodiment has an information processing device 100 and a pen-shaped input device 200.

The information processing device 100 is configured to make it possible to execute information processing in accordance with an inputting operation which is performed by using the pen-shaped input device 200. FIG. 1 illustrates one example that the information processing device 100 is configured as a terminal, a laptop PC or the like.

The information processing device 100 includes a touch panel display unit 102. The touch panel display unit 102 is a unit that a touch panel is combined with a display section. The touch panel display unit 102 displays an image on a display surface and makes it possible to perform an operation of bringing operating bodies such as the pen-shaped input device, a finger and so forth into contact with a display surface.

The pen-shaped input device 200 is a pen-type input device that a user uses for performing an operation to the touch panel on the touch panel display unit 102 of the information processing device 100. The user grips the pen-shaped input device 200, so moves the nib as to be brought into contact with the display surface of the touch panel display unit 102 and thereby performs operations of inputting characters/letters, pictures, graphics and so forth by handwriting.

Incidentally, as operations which are performed by using the pen-shaped input device 200, also a pointing operation and other operations to a user interface image which is displayed on the touch panel display unit 102 may be made also possible.

Incidentally, although there is no particular limitation on a detection system of the pen-shaped input device 200 via a touch panel on the touch panel display unit 102 in the first embodiment, for example, an electrostatic capacitive system, an electromagnetic induction system and so forth may be given. In the following description, a case where the electrostatic capacitive system is used will be given by way of example.

An application (a pen operation adaptive application) which is adaptive to an inputting operation which is performed by using the pen-shaped input device 200 is installed in the information processing device 100.

The pen operation adaptive application may make it possible to execute various kinds of processing and so forth such as, for example, processing of inputting letters/characters which is performed by bringing the nib of the pen-shaped input device 200 into contact with the operational object surface of the touch panel display unit 102, processing of displaying the letters/characters and pictures which are written/drawn in accordance with a handwriting inputting operation such as picture drawing on the touch panel display unit 102, processing of digitalizing the letters/characters and the pictures which are written/drawn by the operations and so forth.

In addition, in the information processing system according to the first embodiment, the pen-shaped input device 200 vibrates correspondingly to a situation that an operation (a writing operation) which accords with writing is being performed. Owing to vibrations of the pen-shaped input device 200 which are generated in this way, it becomes possible for the user to feel a touch sense which is close to a touch sense which is obtained when the user is performing the writing operation on a writing medium such as paper and it becomes possible for the user to obtain a touch sense which is close to the sense which is obtained in a case of performing a writing operation on the writing medium by using a real writing utensil.

In the following description, vibration generation which occurs when a writing operation is being performed by using the pen-shaped input device 200 will be also called “haptic (touch sense) feedback”. The haptic feedback may be controlled in such a manner that the vibrations vary in accordance with a speed which is attained in a case where the pen-shaped input device 200 is moved in a state of contact with the operational object surface of the touch panel display unit 102, a pressure which is applied in a case where the nib of the pen-shaped input device 200 is in contact with the operational object surface and so forth.

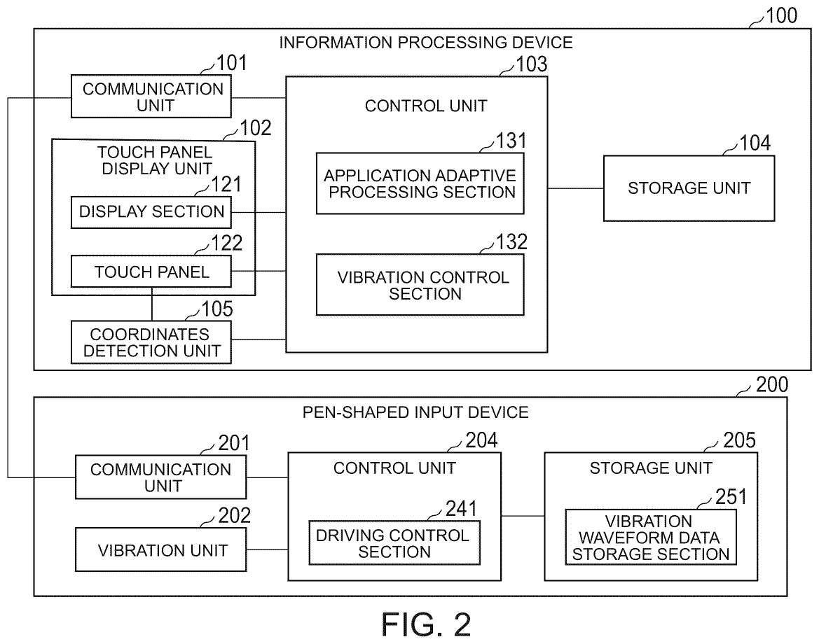

FIG. 2 illustrates the examples of the functional configurations of the information processing device 100 and the pen-shaped input device 200 which accord with vibration control in the first embodiment.

First, the example of the functional configuration of the information processing device 100 will be described. A CPU (Central Processing Unit), a GPU (Graphics Processing Unit) and so forth that hardware which functions as the information processing device 100 includes execute a program and thereby the function of the information processing device 100 which is illustrated in FIG. 2 is realized.

The information processing device 100 in FIG. 2 includes a communication unit 101, the touch panel display unit 102, a control unit (or controller) 103, a storage unit 104 and a coordinates detection unit (or coordinates detector) 105.

The communication unit 101 performs wireless communication with the pen-shaped input device 200. Although there is no particular limitation on the system of the wireless communication that the communication unit 101 deals with, for example, Bluetooth (registered trademark) may be given. Incidentally, the communication unit 101 may be configured to be compatible with wired communication with the pen-shaped input device 200.

Hardware that the communication unit 101 deals with may be configured by installing a communication module which corresponds to a communication system which is implemented on the information processing device 100.

The touch panel display unit 102 is a device that a display section 121 is combined with a touch panel 122 (one example of a sensor section).

The display section 121 displays images in accordance with control by the control unit 103.

The touch panel 122 is installed correspondingly to a display surface of the display section 121, detects the position of the nib of the pen-shaped input device 200 and outputs operation position information which indicates the position which is detected. Specifically, the touch panel 122 of the electrostatic capacitive system may detect the position of the nib on the panel surface by detecting the capacity of static electricity which is generated by contact of the nib of the pen-shaped input device 200 with the panel surface (one example of the operational object surface) by an electrode.

The coordinates detection unit 105 detects the coordinates which correspond to the operation position information which is output from the touch panel 122. That is, the coordinates detection unit 105 converts the position of the panel surface that the operation position information which is output from the touch panel 122 indicates to coordinates. In this case, the coordinates that the coordinates detection unit 105 detects may be two-dimensional coordinates which are set correspondingly to a drawing area which is displayed on the touch panel display unit 102, for example, by using the pen operation adaptive application.

Incidentally, the coordinates detection unit 105 may be installed either on the touch panel display unit 102 or on the control unit 103.

The control unit 103 executes various controlling operations in the information processing device 100. The control unit 103 includes an application adaptive processing section 131 which executes processing which corresponds to the pen operation adaptive application and a vibration control section 132.

In a case where the nib of the pen-shaped input device 200 is brought into contact with the panel surface of the touch panel 122 as an operation to be performed for the pen operation adaptive application, the pen operation information is input into the application adaptive processing section 131 from the touch panel 122. The application adaptive processing section 131 performs processing such as drawing, for example, in accordance with input of the pen operation information.

The vibration control section 132 executes control (vibration control) for vibrating the pen-shaped input device 200. The vibration control section 132 transmits vibration control information for instructing the pen-shaped input device 200 so as to vibrate to the pen-shaped input device 200. The vibration control information may contain, for example, vibration intensity as a parameter. The pen-shaped input device 200 so operates as to vibrate at vibration intensity which is contained in the vibration control information in accordance with reception of the vibration control information.

The control unit 103 may be configured as a computer which includes a CPU, a GPU, a RAM, a ROM and so forth as hardware.

The storage unit 104 stores various kinds of information which relates to the information processing device 100.

Hardware that the storage unit 104 is adaptive may be, for example, an HDD (Hard Disk Drive), an SSD (Solid State Drive), a flash memory and so forth.

Next, the example of the functional configuration of the pen-shaped input device 200 will be described. The function of the pen-shaped input device 200 which is illustrated in FIG. 2 may be realized by making a microprocessor such as an MCU (Micro Controller Unit), for example, the pen-shaped input device 200 which functions as hardware includes execute the program.

The pen-shaped input device 200 in FIG. 2 includes a communication unit 201, a vibration unit 202, a control unit 204 and a storage unit 205.

The communication unit 201 is connected with the communication unit 101 of the information processing device 100 to be communicable. The communication unit 201 may be configured by being equipped with hardware which is adaptive to, for example, a communication system which is implemented. Hardware that the communication unit 201 deals with may be configured by including a communication module which is adaptive to the communication system which is implemented on the pen-shaped input device 200.

The vibration unit 202 (an actuator) is a unit which vibrates so as to give the touch sense which is obtained when performing, for example, a writing operation to the user who is performing an operation of moving the nib of the pen-shaped input device 200 on the panel surface of the touch panel 122. The vibrations that the vibration unit 202 generates are controlled by a driving control section 241.

The control unit 204 executes various controlling operations in the pen-shaped input device 200. The control unit 204 includes the driving control section 241.

The driving control section 241 so drives as to vibrate the vibration unit 202 by utilizing vibration waveform data that a vibration waveform data storage section 251 stores.

The storage unit 205 stores various kinds of information that the pen-shaped input device 200 deals with. The storage unit 205 includes the vibration waveform data storage section 251. The vibration waveform data storage section 251 stores the vibration waveform data. The vibration waveform data is data which indicates vibration waveforms for making the pen-shaped input device 200 generate a desirable vibration state.

Hardware that the storage unit 205 is adaptive may be, for example, a flash memory and so forth.

The pen-shaped input device 200 of the information processing system in the first embodiment which is so configured as above is capable of applying the haptic feedback. That is, the pen-shaped input device 200 in the first embodiment is configured to be able to operate so as to vibrate correspondingly to a situation that an operation (a pen moving operation) of moving the pen-shaped input device 200 is being performed while bringing the nib into contact with the panel surface of the touch panel display unit 102 (the touch panel 122). The pen-shaped input device 200 vibrates in a case where a writing operation is being performed as the pen moving operation such as the above and thereby it becomes possible to get closer to the sense which is obtained in a case where the writing operation is performed on the writing medium by using a real writing utensil.

In a case where, for example, convenience and so forth of the user who utilizes the information processing device 100 are taken into consideration, it is preferable to increase usability of vibration control under which the pen-shaped input device 200 is vibrated by expanding the function of the haptic feedback and applying the vibration control also to functions other than the function of the haptic feedback.

In the pen operation adaptive application in the first embodiment, it becomes possible to draw a line (a patterned line) that a line section and a non-line section are repetitively drawn in a predetermined pattern such as a dotted line, a broken line and a chain line (a one-dot chain line, a two-dot chain line and so forth) using the pen-shaped input device 200. In drawing the patterned lines, the user performs a writing operation of moving the nib of the pen-shaped input device 200 so as to draw one line while bringing the nib of the pen-shaped input device 200 into contact with the operational object surface. In accordance with a situation that the writing operation has been performed in this way, selected patterned lines are drawn along a movement locus of the nib of the pen-shaped input device 200.

Accordingly, in the information processing system of the first embodiment, in a case where a writing operation of moving the nib on the panel surface is being performed correspondingly to drawing of the patterned line, vibration control is performed in such a manner that vibrations which function as the haptic feedback are generated on the line part of the patterned line and the vibrations are not generated on the nonlinear part.

The vibration control is performed in this way and thereby the haptic feedback is expanded so as to vibrate at a timing that the line part is drawn and not to vibrate at a timing that the non-liner part is drawn, correspondingly to the writing operation of moving the nib on the panel surface in order to draw the patterned line. Thereby, the user receives the haptic feedback which is set to switch between a vibrated state and a non-vibrated state when the user is performing a writing operation of drawing the patterned line and it becomes possible for the user to really feel that the user is drawing the patterned line.

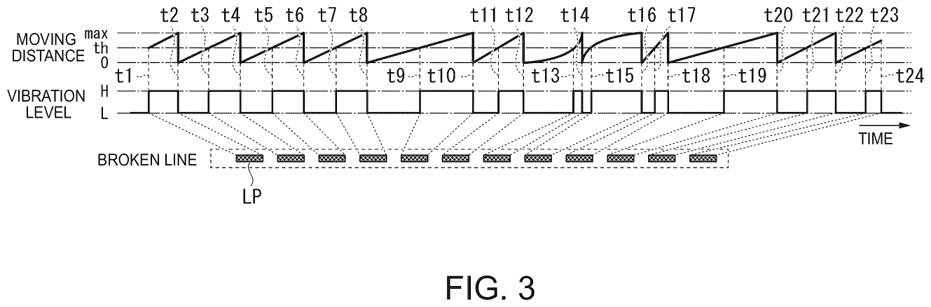

One example of vibration control which deals with drawing of the patterned line in the first embodiment will be described with reference to FIG. 3.

For example, the user selects a certain patterned line as an object to be drawn by operating the pen operation adaptive application. Then, the user starts to perform a writing operation for drawing the patterned line at a time t1. That is, the user brings the nib of the pen-type input device 200 into contact with the panel surface of the touch panel 122 in order to draw the patterned line at the time t1.

In the information processing device 100, the vibration control section 132 sets a range from zero (“0”) to a predetermined maximum value (max) as a moving distance range of the nib on the panel surface correspondingly to drawing of the patterned line and sets a certain distance in the moving distance range as a threshold value th. The maximum value (max) and the threshold value th in the moving distance range are determined depending on a repetitive pattern of the line part and the non-line part in the patterned line. In description of the example in FIG. 3, a case where the patterned line is a broken line and has a pattern (one example of the section pattern) that the line part and the non-line part are repeated with the same length is given by way of example.

After the time t1, the user performs a writing operation so as to move the nib of the pen-shaped input device 200 on the panel surface for line drawing. The vibration control section 132 measures a moving distance of the nib on the basis of coordinate change which is detected by the coordinates control unit 105 in accordance with movement of the nib on the panel surface after the time t1. The vibration control section 132 sets the threshold value th as an initial value of the moving distance at the time t1 that movement of the nib is started as illustrated in FIG. 3.

The moving distance which is measured after the time t1 increases as time advances and reaches the maximum value max at a time t2. In a case where the moving distance reaches the maximum value max, the vibration control section 132 resets the value to zero and operates to resume measurement from zero. The moving distance is increased as the vibration control section 132 measures the moving distance after the time t2, reaches a threshold value th at a time t3 and then reaches the maximum max at a time t4. The vibration control section 132 resets the moving distance to zero at a time t4 and then resumes measurement. The vibration control section 132 repetitively measures the moving distances which range from zero to the maximum value max on the basis of the coordinates which are detected by the coordinate detection unit 105 in accordance with movement of the nib on the panel surface in this way.

In drawing the broken lines, the application adaptive processing section 131 draws a line part LP in a case where the moving distance that the vibration control section 132 measured is more than the threshold value th and draws a non-linear part in a case where the moving distance is less than the threshold value th.

In addition, in a case where the moving distance exceeds the threshold value th, the vibration control section 132 controls to vibrate the pen-shaped input device 200 and in a case where the moving distance is less than the threshold value th, the vibration control section 132 controls to stop the vibration of the pen-shaped input device 200. The vibration control section 132 so controls as to switch between ON and OFF of vibration generation that the vibration control section 132 makes the pen-shaped input device 200 perform depending on whether the moving distance is more than the threshold value th or not.

Drawing and vibration control are performed in this way and thereby the broken line is drawn on the touch panel display section 102 in accordance with the writing operation of the user and in addition it becomes possible for the pen-shaped input device 200 to vibrate at each timing that the line part is drawn.

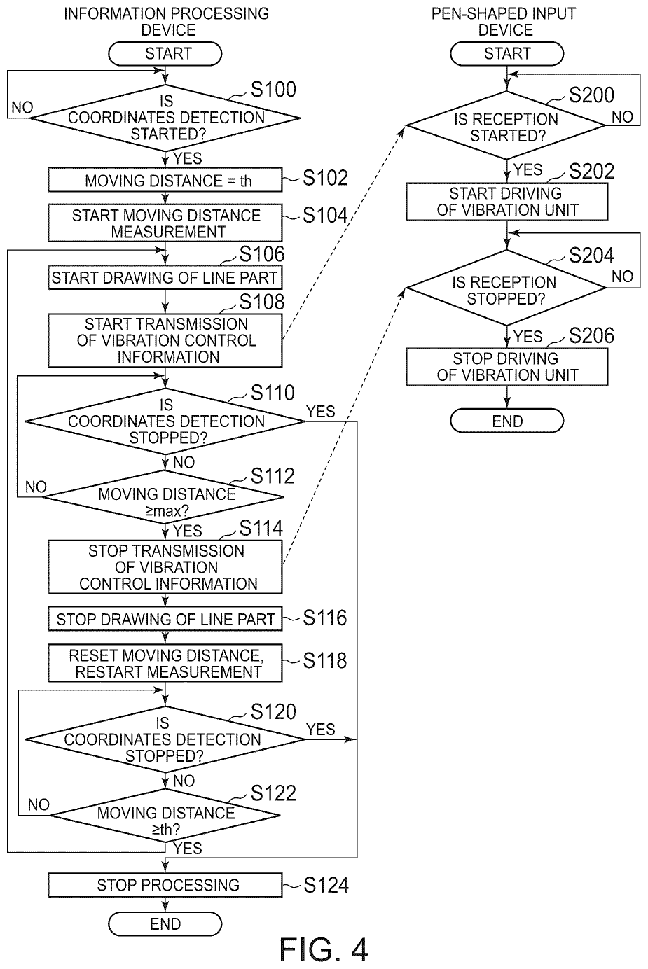

Examples of the processing procedures that the information processing device 100 and the pen-shaped input device 200 in the second embodiment execute in relation to vibration control in pattern line drawing will be described with reference to the flowcharts in FIG. 4. As for the processing procedures in FIG. 4, a case where a pattern line which is to be drawn is a broken line of a pattern that the line part and the broken part are arranged alternately with the same length in the same manner as that in FIG. 3 will be given by way of example.

First, the example of the processing procedures that the information processing device 100 executes will be described.

Step S100: In the information processing device 100, the vibration control section 132 stands by for start of detection of coordinates by the coordinates detection unit 105. The coordinates detection unit 105 starts detection of the coordinates in accordance with a situation that the nib of the pen-shaped input device 200 begins to come into contact with the panel surface of the touch panel 122.

Step S102: In accordance with start of the detection of the coordinates in the step S100, the vibration control section 132 sets the threshold value th as an initial value of a moving distance to be measured.

Step S104: In addition, the vibration control section 132 starts measurement of the moving distance in accordance with start of detection of the coordinates in the step S100.

Step S106: The moving distance is in a state of being set to a value which is more than the threshold value th at the present time. Accordingly, the application adaptive processing section 131 starts drawing of the line part in the broken line. The application adaptive processing section 131 so operates as to draw the line part at a position which corresponds to the coordinates which are detected by the coordinates detection unit 105 on a plane for drawing.

Step S108: In addition, the vibration control section 132 starts transmission of the vibration control information to the pen-shaped input device 200 so as to vibrate the pen-shaped input device 200.

Step S110: The vibration control section 132 decides whether detection of the coordinates which has been performed so far by the coordinates detection unit 105 is stopped. Detection of the coordinates by the coordinates detection unit 105 is stopped in accordance with a situation that the user separates the nib of the pen-shape input device 200 from the panel surface of the touch panel 122 in order to terminate a writing operation for line drawing.

Step S112: In a case where it is decided that detection of the coordinates is not stopped in the step S110, the vibration control section 132 decides whether the moving distance which is being currently measured is more than the maximum value max. In a case where the moving distance is less than the maximum value max, the process is returned to the step S110.

Step S114: In a case where it is decided that the moving distance is more than the maximum value max in the step S112, the vibration control section 132 stops transmission of the vibration control information which is started in the step S108.

Step S116: In addition, in accordance with a situation that the moving distance exceeds the maximum value max, the application adaptive processing section 131 stops drawing of the line part which is started in the step S106.

Step S118: In addition, in accordance with the situation that the moving distance exceeds the maximum value max, the vibration control section 132 resets the values of the moving distance which have been measured so far to zero and then controls to restart measurement of the moving distance.

Step S120: The vibration control section 132 decides whether detection of the coordinates which has been conducted so far by the coordinate detection unit 105 is stopped.

Step S122: In addition, the vibration control section 132 decides whether the moving distance which is being currently measured is more than the threshold value th. In a case where the moving distance is less than the threshold value th, the process is returned to the step S120. While the processes in the steps S120 and S122 are being looped, drawing of the line part in the dashed line is not performed, a non-linear part is formed and also the vibration of the pen-type input device 200 is stopped.

On the other hand, in a case where the moving distance is more than the threshold value th, the process is returned to the step S106 and thereby drawing of the line part and transmission of the vibration control information which is used for vibrating the pen-shaped input device 200 is started.

Step S124: In a case where it is decided that detection of the coordinates is stopped in the step S110 or the step S120, stop processing is executed. As the stop processing, in a case where the application adaptive processing section 131 draws the line part, the application adaptive processing section 131 stops drawing of the line part and the vibration control section 132 terminates measurement of the moving distance and, in a case where the vibration control section 132 transmits the vibration control information, the vibration control section 132 stops transmission of the vibration control information.

Next, the example of the processing procedures that the pen-shaped input device 200 executes will be described.

Step S200: In the pen-shaped input device 200, the driving control section 241 stands by for start of reception of the vibration control information which is transmitted thereto in the step S108.

Step S202: In a case where reception of the vibration control information is started, the driving control section 241 starts driving of the vibration unit 202 on the basis of vibration waveform data that the vibration waveform data storage section 251 stores. On this occasion, in a case where vibration intensity is designated in the vibration control information, the driving control section 241 may drive in such a manner that the vibration unit 202 vibrates at the vibration intensity which is designated.

Step S204: After start of driving of the vibration unit 202 in the step S2012, the driving control section 241 stands by for stop of reception of the vibration control information which has been received so far.

Step S206: In accordance with stop of reception of the vibration control information, the driving control section 241 stops driving of the vibration unit 202 which has been performed so far.

### Second Embodiment

Then, the second embodiment of the information processing system will be described. In the second embodiment, the user is guided to perform an operation (a pen moving operation) of moving the pen-shaped input device 200 while bringing the nib of the pen-shaped input device 200 into contact with the panel surface of the touch panel 122. In performing a nib moving operation, coordinates which are detected by the coordinates detection unit 105 vary (move). In the second embodiment, in a case where the pen moving operation is being performed as vibration control, on the occasion that the coordinates which vary correspondingly to movement of the nib pass a boundary line of a predetermined pattern which is set on a coordinate plane which faces the panel surface, the pen-shaped input device 200 is temporally vibrated.

The configurations of the information processing device 100 and the pen-shaped input device 200 are as illustrated in FIG. 2.

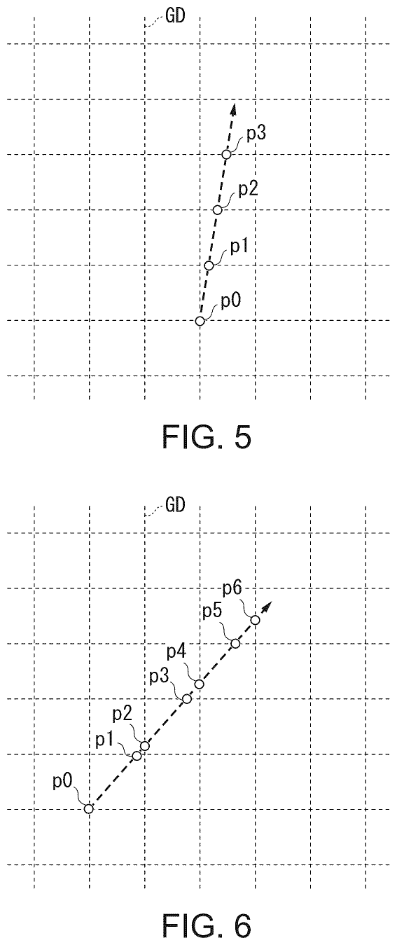

FIG. 5 illustrates one (a first application example) of application examples of vibration control in the second embodiment. In the second embodiment, in accordance with a situation that the user firstly brings the nib of the pen-shaped input device 200 into contact with the panel surface of the touch panel 122, the vibration control section 132 sets the coordinates of a position with which the nib is brought into contact on the coordinate plane as reference coordinates p0. In addition, the vibration control section 132 sets a grid GD. In setting the grid GD, the vibration control section 132 operates in such a manner that the reference coordinates p0 correspond to one of intersections between a horizontal grid line (a boundary line) and a vertical grid line.

The user performs a pen moving operation in a given direction in a state of bringing the nib into contact with the panel surface, starting from the point of the reference coordinates p0. In FIG. 5, as indicated by a broken-line arrow, an example that the nib is moved in a diagonally upward direction from the point of the reference coordinates p0 is illustrated.

In a case where the nib is moved as illustrated in FIG. 5, it means that the nib is positioned on the grid line in the order of coordinates p1, p2 and p3 on the vertical-direction grid line which are arranged in a row direction. In the second embodiment, the vibration control section 132 controls to temporally vibrate the pen-shaped input device 200 every time that the nib enters a state of being located on positions of coordinates p1, p2 and p3. That is, in the second embodiment, every time that the nib passes through the grid line on a coordinate plane, temporal pulsed vibrations (pulsed vibrations (one example of temporal vibrations) are generated every time that the nib passes over the grid line on a coordinate plane.

The pulsed vibrations are generated in this way and thereby it becomes possible for the user to grasp intuitively the degree of a moving distance from the reference coordinates p0 on the coordinate plane which accords with the nib that the user moves by a pen moving operation.

FIG. 6 illustrates one example of a result of vibration control which is performed in a case where the nib is moved from the point of the reference coordinates p0 in a moving direction which is different from the moving direction in FIG. 5. In the case in FIG. 6, pulsed vibrations are generated every time that the nib passes through the grid lines in the order of the points of coordinates p1, p2, p3, p4, p5 and p6 depending on movement of the nib from the point of the reference coordinates p0.

In this case, since the gradient of the slope is gentler than that in FIG. 5, the nib passes through not only the points of the coordinates p1, p3 and p5 on the grid line which is arranged in a horizontal direction but also the points of the coordinates p2, p4 and p6 on the grid line which is arranged in a vertical direction. Accordingly, it becomes possible for the user to sensuously grasp the degree of the moving distance which is measured from the reference coordinates p0 in directional components which are oriented in the vertical direction and the horizontal direction respectively.

That is, in the second embodiment, a reference position and a boundary line that the reference position is set as a standard are set on a coordinate plane in response to start of the pen moving operation which is performed by using the pen-shaped input device 200. Then, vibration control is performed in such a manner that pulsed vibrations are generated from the pen-shaped input device 200 at a timing that the coordinates which move from the reference position pass across the boundary line in accordance with movement of the nib.

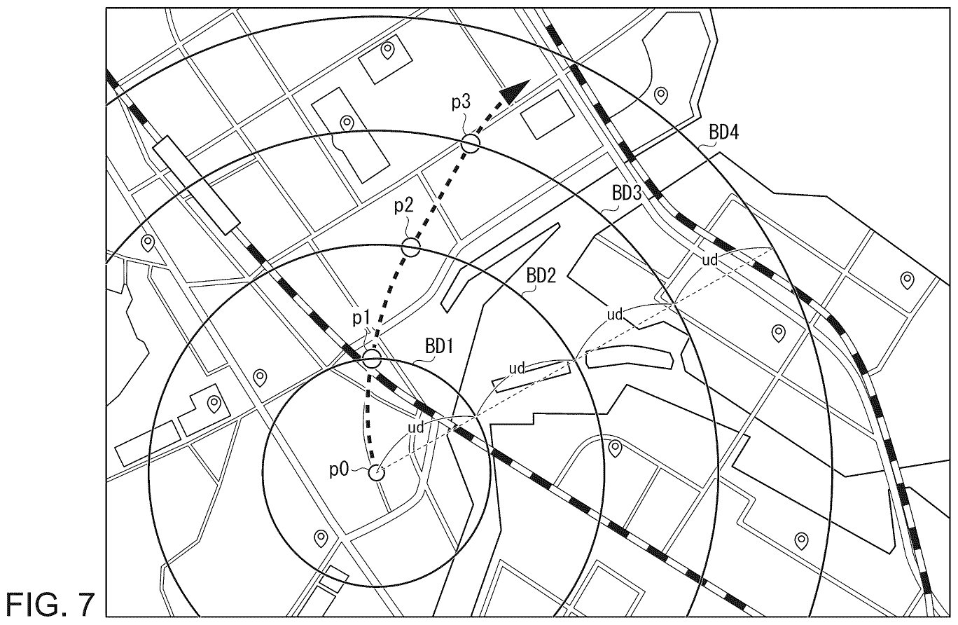

FIG. 7 illustrates another application example (the second application example) of the vibration control in the second embodiment. In the second application example, the pen operation adaptive application has a function of presenting a map. In the second application example, the map is displayed on the touch panel display unit 102 as illustrated in FIG. 7.

The user performs an operation (a start point designating operation) of designating an arbitrary position on the map which is displayed as a start point. The start point designation operation may be an operation of bringing the nib of the pen-shaped input device 200 into contact with the position of the start point on the map.

The position of the start point on the map which is designated by a start point designating operation is set as the reference coordinates p0 on the coordinate plane.

In addition, in accordance with the start point designating operation, a plurality of circular boundary lines BD (BD 1 to BD 4) is set with the reference coordinates p0 being set as a common center. In FIG. 7, the boundary line BD 1 is so set as to have a radius which corresponds to a unit moving distance ud and then the mutually adjacent boundary lines BD are disposed at equal intervals across the unit moving distance ud.

The boundary line BD may be displayed on the map and may not be displayed on the map. In addition, display and non-display of the boundary line BD may be made to be switchable, for example, in accordance with a pen-operation-adaptive-application-based operation which is performed by the user.

The unit movement distance ud is defined to be optionally settable by the user correspondingly to a reduced scale of the map by performing the pen-operation-adaptive-application-based operation. Incidentally, the unit movement distance ud may be fixed.

The user moves the nib from a state that the nib of the pen-shaped input device 200 is brought into contact with the panel surface on which the map is displayed by performing a start point designating operation toward a destination. The nib is moved in this way and thereby the nib passes through the boundary lines BD, for example, in the order of the coordinates p1 on the boundary line BD 1, the coordinates p2 on the boundary line BD2 and the coordinates p3 on the boundary line BD3 as illustrated in FIG. 7.

In the second application example, vibration control is performed in such a manner that every time that the nib is located on each coordinate point on the boundary line BD, pulsed vibrations are generated from the pen-shaped input device 200. The vibration control is performed in this way and thereby it becomes possible for the user to readily grasp an approximate distance from the start point to the destination in accordance with the number of times of pulse vibrations which are generated while the nib is being moved from the start point to the destination.

Incidentally, in the second application example, the intensity of pulse vibration may be changed in accordance with a distance from the start point to the destination.

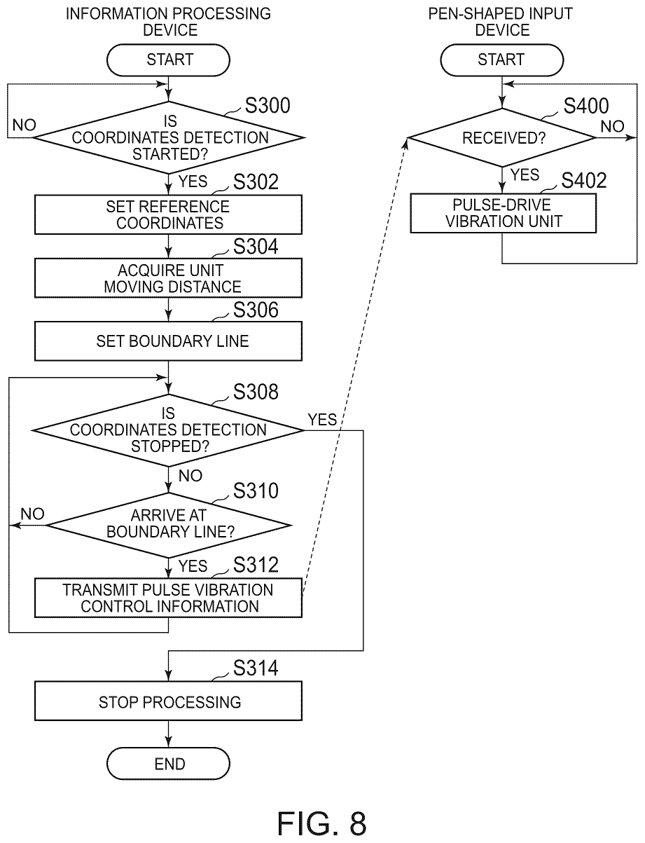

Examples of processing procedures that the information processing device 100 and the pen-shaped input device 200 execute correspondingly to the vibration control in FIG. 7 will be described with reference to flowcharts in FIG. 8.

First, the example of the processing procedures that the information processing device 100 executes will be described.

Step S300: In the information processing device 100, the vibration control section 132 stands by for start of detection of the coordinates by the coordinates detection unit 105.

Step S302: In a case where detection of the coordinates is started, the vibration control section 132 sets coordinates which are detected firstly on a map-adaptive coordinate plane as the reference coordinates p0.

Step S304: In addition, in accordance with start of the detection of the coordinates, the vibration control section 132 acquires the unit moving distance ud which is set by the user.

Step S306: The vibration control section 132 sets the boundary lines BD on the map-adaptive coordinate plane by utilizing the reference coordinates p0 which are set in the step S302 and the unit moving distance which is acquired in the step S304.

Step S308: The vibration control section 132 decides whether detection of the coordinates which is started in the step S300 is stopped.

Step S310: In a case where it is decided that detection of the coordinates is not stopped in the step S308, the vibration control section 132 decides whether the coordinates which are detected at the present reach the boundary line BD. In a case where it is decided that the coordinates do not reach the boundary line BD, the process is returned to the step S308.

Step S312: In a case where it is decided that the coordinates reach the boundary line BD in the step S310, the vibration control section 132 transmits pulsed vibration control information to the pen-shaped input device 200.

Step S314: In a case that it is decided that the detection of the coordinates is stopped in the step S308, stop processing is executed. As the stop processing, the vibration control section 132 clears the reference coordinates p0 which are set in the step S302 and the boundary line BD which is set in the step S306.

Next, the example of the processing procedures that the pen-shaped input device 200 executes will be described.

Step S400: In the pen-shaped input device 200, the vibration control section 241 stands by for reception of the pulsed vibration control information which is transmitted from the information processing device 100 in the step S312.

Step S402: In accordance with reception of the pulsed vibration control information, the driving control section 241 drives the vibration unit 202 so as to generate the pulsed vibrations.

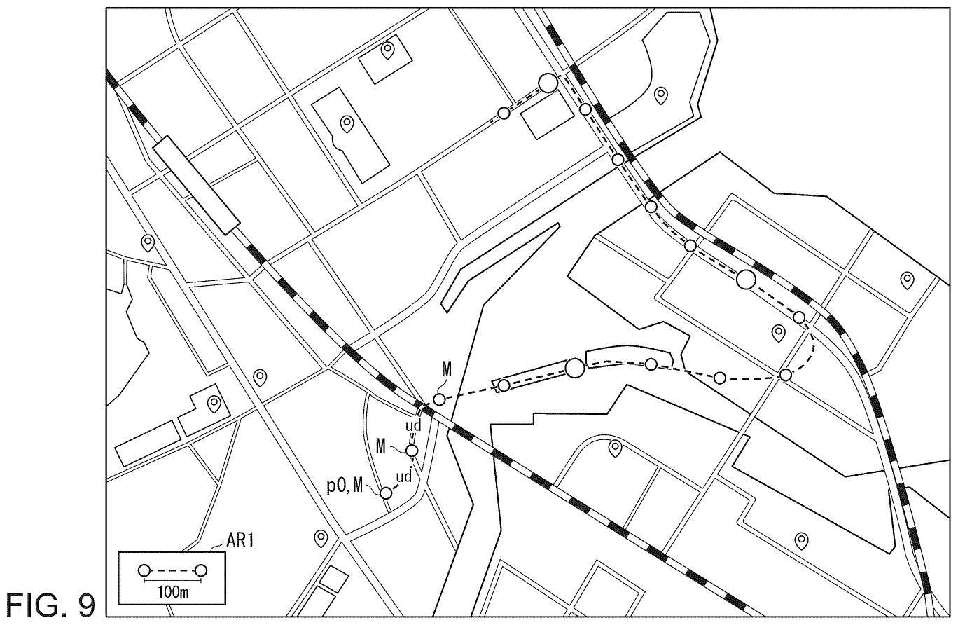

FIG. 9 illustrates the third application example of the second embodiment. Also in the third application example, the pen operation adaptive application has the function of presenting the map and the map is displayed on the touch panel display unit 102 as illustrated in FIG. 9.

The user performs a start point designating operation on the map which is displayed. The coordinates of the start point on the map which are designated by the start point designating operation are set as the reference coordinates p0.

The user moves the nib along a route to a destination from a state that the nib of the pen-shaped input device 200 is brought into contact with the panel surface on which the map is displayed by performing the start point designating operation. It becomes possible for the user to move the nib along a route which is optionally determined on the map. The pen operation adaptive application may be made so as to indicate the route by displaying the locus along which the nib is moved.

In the third application example, vibration control is performed in such a manner that every time that the moving distance along the route on the map which accords with the movement of the nib is extended by the unit moving distance ud which is set correspondingly to the map scale, pulsed vibrations are generated from the pen-shaped input device 200.

It becomes possible for the user to readily grasp the distance of the route which is measured from the start point in accordance with the number of times that the pulsed vibrations are generated while the user is moving the nib from the start point to the destination by performing the vibration control in this way.

Incidentally, in a case where the route is displayed on the map, a mark M may be displayed per position of the reference coordinates p0 and per unit moving distance ud which is measured from the point of the reference coordinates p0 on the route which is displayed.

### Third Embodiment

Then, the third embodiment will be described. In the third embodiment, the pen-shaped input device 200 is configured to continuously vibrate correspondingly to a situation that the user is performing the pen moving operation and then the vibration intensity of the pen-shaped input device 200 is changed in accordance with a positional relation of the coordinates (the current coordinates) which are detected while the pen moving operation is being performed relative to the reference coordinates p0.

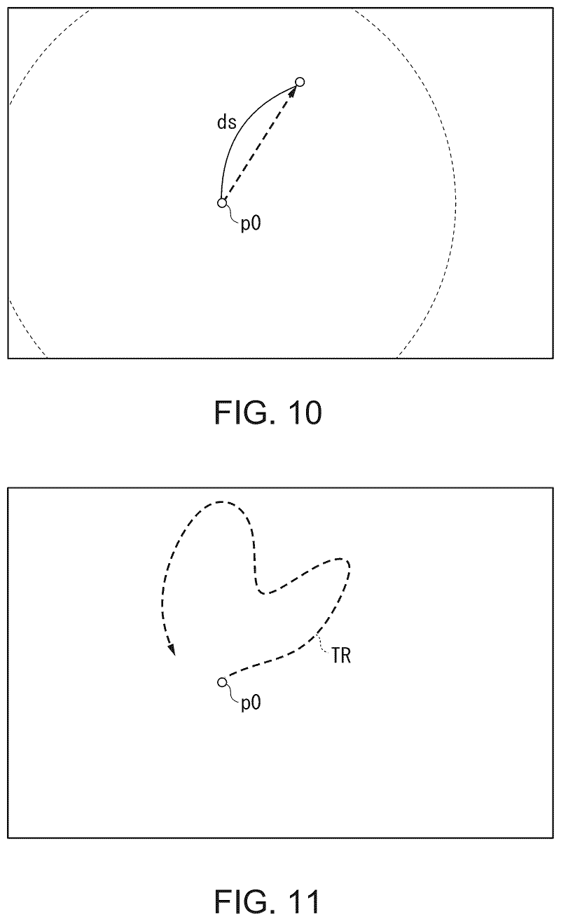

FIG. 10 illustrates the first application example in the third embodiment. In the first application example, the reference coordinates p0 are set correspondingly to start of the pen moving operation by the user. That is, the user brings the nib of the pen-shaped input device 200 into contact with the panel surface of the touch panel 122 for start of the pen moving operation. The vibration control section 132 of the information processing device 100 sets the coordinates which are firstly detected by the coordinates detection unit 105 as the reference coordinates p0 in accordance with contact of the pen with the panel surface.

The user brings the nib of the pen-shaped input device 200 into contact with the panel surface as described above and then performs the pen moving operation so as to move the nib while maintaining a state that the nib is brought into contact with the panel surface.

As the pen moving operation is performed, the current coordinates that the coordinate detection unit 105 detects change accordingly. The vibration control section 132 calculates the distance between the current coordinates and the reference coordinates p0 and changes the vibration intensity of the pen-shaped input device 200 depending on the distance which is calculated. Specifically, the vibration control section 132 may set to increase also the vibration intensity as the distance ds which is calculated is increased. The vibration control section 132 transmits vibration control information which contains the vibration intensity which is set to the pen-shaped input device 200.

The driving control section 241 in the pen-shaped input device 200 makes the vibration unit 202 vibrate depending on the vibration intensity which is contained in the vibration control information which is received in accordance with reception of the vibration control information. As a result, the pen-shaped input device 200 is so operated as to change the vibration intensity in accordance with change of the distance ds which is measured from the reference coordinates p0 which is obtained in a case where the pen moving operation is being performed. Owing to change of the vibration intensity in this way, it becomes possible for the user to sensuously grasp how far the nib of the pen-shaped input device 100 which is currently put on the panel surface is located away from the point of the reference coordinates p0 in terms of distance.

Incidentally, in FIG. 10, a broken-line circle that the reference coordinates p0 are centered is illustrated. A broken-lined circle in FIG. 10 is an auxiliary line which indicates that the distance ds in the first application example is the auxiliary line which indicates that the distance ds in the first application example is the one which is calculated in the direction of 360° centering on the reference coordinates p0 and may not be displayed on the touch panel display section 102.

FIG. 11 illustrates the second application example of the third embodiment. Also in the second application example, the coordinates which are detected by the coordinates detection unit 105 in a case where the nib of the pen-shaped input device 200 firstly comes into contact with the panel surface are set as the reference coordinates p0 at the start of the pen moving operation.

Then, it becomes possible for the user to perform the pen moving operation so as to move the nib in an optional direction while maintaining a state that the nib is brought into contact with the panel surface. In FIG. 11, a movement locus TR of the nib which is obtained by a pen moving operation which is performed by setting the reference coordinates p0 that the nib is firstly brought into contact with the panel surface as the start point is indicated.

In the second application example, on the occasion that the nib is moved in an optional direction by performing the pen moving operation as described above, vibration intensity of the pen-shaped input device 200 is changed depending on whether the direction (the coordinates moving direction) that the coordinates which are detected by the coordinates detection unit 105 move is a direction that the coordinates come closer to the reference coordinates p0 or a direction that the coordinates is separated from the reference coordinates p0.

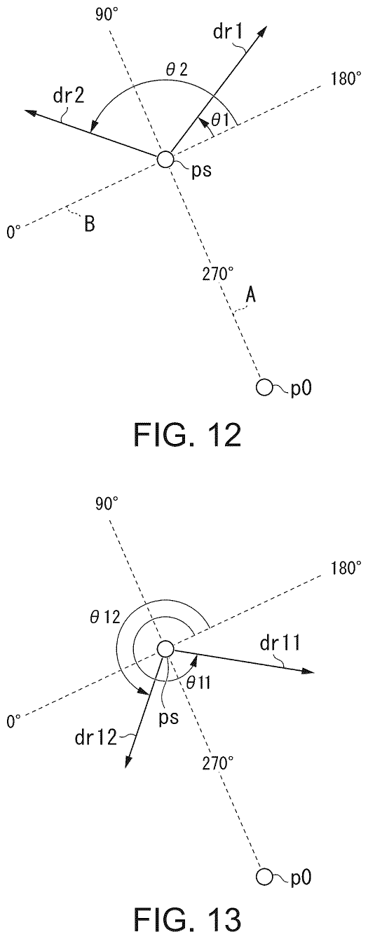

One example of a technique of deciding whether the direction that the coordinates moves is the direction that the coordinates come closer to the reference coordinates p0 or the direction that the coordinates are separated from the reference coordinates p0 will be described with reference to FIG. 12 and FIG. 13.

The vibration control section 132 calculates the direction that the current coordinates change (the coordinates moving direction), for example, by performing differentiation or the like on a plurality of current coordinates which is detected by the coordinates detection unit 105 at different times. The coordinates moving direction which is calculated in this way may be obtained as a directional component in the vector.

The vibration control section 132 sets a straight-line A which passes through the reference coordinates p0 and the current coordinates ps and a straight-line B which passes through the current coordinates ps orthogonally to the straight-line A as illustrated in FIG. 12. The vibration control section 132 sets angles 0° to 360° which center on the current coordinates ps by setting the straight lines A and B, for example, as a y-axis and an x-axis respectively.

In FIG. 12, two examples of a coordinates moving direction dr1 which has an angle θ1 and a coordinates moving direction dr2 which has an angle θ2 are illustrated in FIG. 12 as the coordinates moving directions that the vibration control section 132 calculates as described above. In a case where an angle θ(n) which is formed in a unit circle is in a range from 0° to 180°, the vibration control section 132 decides that the coordinate moving direction is a direction (a separation direction) that the coordinates are separated from the reference coordinates p0. That is, the vibration control section 132 decides that both of the coordinate moving directions dr1 and dr2 which are illustrated in FIG. 12 are the separation directions.

In addition, two examples, that is, one example of a coordinates moving direction dr11 which has an angle θ11 and one example of a coordinates moving direction dr12 which has an angle θ12 are illustrated in FIG. 13 as the coordinates moving directions that the vibration control section 132 calculates. In a case where the angle θ(n) which is formed in the unit circle is in a range from an angle which is larger than 180° to an angle which is less than 360°, the vibration control section 132 decides that the coordinates moving direction is a direction (an approaching direction) which approaches the reference coordinates p0. Accordingly, the vibration control section 132 decides that both of the coordinates moving directions dr11 and dr12 which are illustrated in FIG. 13 are approaching directions.

The vibration control section 132 controls in such a manner that the aspect of the vibration of the pen-shaped input device 200 is changed depending on whether the coordinate moving direction is either the separating direction or the approaching direction.

For example, the vibration control section 132 may change the intensity (the vibration intensity) which makes the pen-shaped input device 200 vibrate depending on whether the coordinates moving direction is the separating direction or the approaching direction. Specifically, controlling may be performed in such a manner that the pen-shaped input device 200 vibrates with predetermined intensity correspondingly to a situation that the coordinate moving direction is the separating direction and the pen-shaped input device 200 does not vibrate (the vibration intensity is zero) or vibrates with intensity which is lower than that which is obtained in a case where the pen-shaped input device 200 does not vibrate (the vibration intensity is zero) or vibrates with the intensity which is lower than that in the case where the coordinate moving direction is the approaching direction.

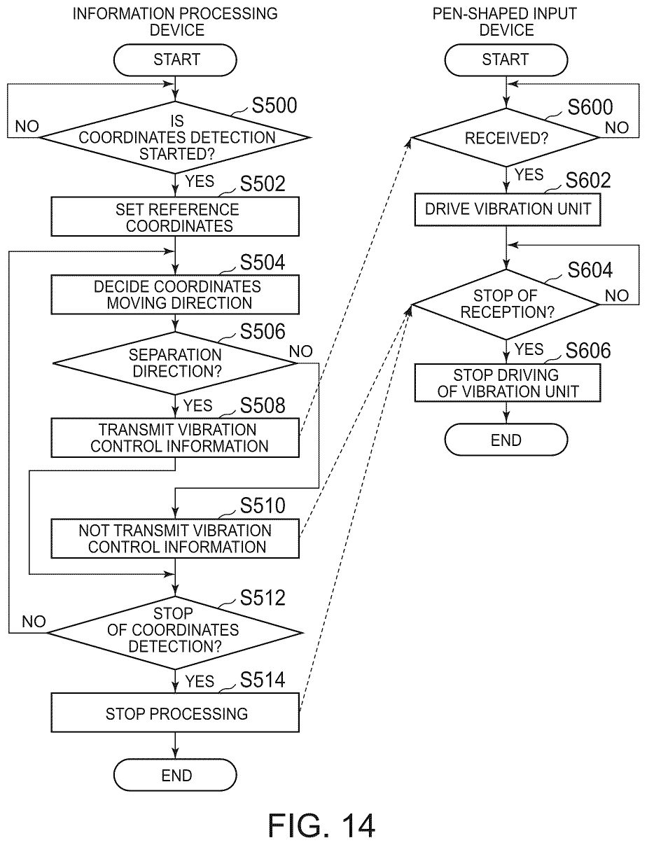

Examples of the processing procedures that the information processing device 100 and the pen-shaped input device 200 execute correspondingly to the second application example of the third embodiment will be described with reference to the flowcharts in FIG. 14.

First, the example of the processing procedures that the information processing device 100 executes will be described.

Step S500: In the information processing device 100, the vibration control section 132 stands by for start of detection of the coordinates by the coordinates detection unit 105.

Step S502: In a case where detection of the coordinates is started, the vibration control section 132 sets the coordinates which are firstly detected on the coordinate plane to which the map corresponds as the reference coordinates p0.

Step S504: The vibration control section 132 decides whether a coordinates moving direction of the current coordinates which move correspondingly to a pen moving operation which is performed after the reference coordinates p0 have been set is either the separating direction or the approaching direction.

Step S506: The vibration control section 132 decides whether the coordinates moving direction which is decided in the step S504 is the separating direction or not.

Step S508: In a case where it is decided that the coordinates moving direction is the separating direction in the step S506, the vibration control section 132 transmits vibration control information.

Step S510: In a case where it is decided that the coordinates moving direction is not the separating direction but the approaching direction in the step S506, the vibration control section 132 so controls as not to transmit the vibration control information. On this occasion, in a case where the vibration control information has been transmitted so far, the vibration control section 132 stops transmission of the vibration control information which has been transmitted so far in the step S510.

Step S512: The vibration control section 132 decides whether detection of the coordinates which is started in the step S300 is stopped or not. In a case where it is decided that the coordinates detection is not stopped, the process is returned to the step S504.

Step S514: In a case where it is decided that detection of the coordinates is stopped in the step S512, the stop processing is executed. As the stop processing, the vibration control section 132 clears the reference coordinates p0 which have been set in the step S502 and, in a case where the vibration control information has been transmitted so far in the step S508, stops transmission of the vibration control information.

Next, the example of the processing procedures that the pen-shaped input device 200 executes will be described.

Step S600: In the pen-shaped input device 200, the driving control section 241 stands by for reception of the vibration control information which has been transmitted from the information processing device 100 in the step S312.

Step S602: In accordance with reception of the vibration control information, the driving control section 241 drives the vibration unit 202 so as to generate vibrations in the pen-shaped input device 200.

Step S604: The driving control section 241 stands by for termination of reception of the vibration control information which has been received so far.

Step S606: In a case where reception of the vibration control information is stopped, the driving control section 241 stops driving of the vibration unit 202. Driving of the vibration unit 202 is stopped and thereby generation of the vibrations from the pen-shaped input device 200 is stopped.

Incidentally, in the step S510, the vibration control section 132 may transmit vibration control information for designating zero as the vibration intensity. In this case, the driving control section 241 of the pen-shaped input device 200 may control to drive the vibration unit 202 with vibration intensity that the vibration control information which is received indicates. In this situation, in a case where the vibration intensity that the vibration control information indicates is zero, the driving control section 241 may stop driving of the vibration unit 202.

Then, in the second application example, the vibration intensity may be changed, for example, in accordance with the angle θ which is defined in the coordinate moving direction in a unit circle that the point of current coordinates ps is set as an original point. For example, in a case where the coordinates moving direction is the separating direction, the vibration control section 132 may control in such a manner that as the angle θ approaches 90°, the more the vibration intensity of the pen-shaped input device 200 is increased and in a case where the coordinate moving direction is the approaching direction, the vibration control section 132 may control in such a manner that as the angle θ approaches 270°, the more the vibration intensity of the pen-shaped input device 200 is increased.

Further, the vibration control section 132 may control in such a manner that the vibration intensity of the pen-shaped input device 200 varies in accordance with the distance from the point of the reference coordinates p0 to the point of the current coordinates ps.

Incidentally, processing that the above-described information processing device 100, the pen-shaped input device 200 and so forth are to perform may be also performed by recording a program for realizing the functions of the above-described information processing device 100, the pen-shaped input device 200 and so forth into a computer-readable recording medium, by reading the program which is recorded in this recording medium into a computer system and by executing the program. Here, “reading the program which is recorded in the recording medium into the computer system and executing the program” includes to install the program into the computer system. Here, “the computer system” shall include OS and hardware such as peripherals. In addition, “the computer system” may also include a plurality of computer devices (in correspondence with the embodiments of the present invention, a personal computer, a tablet terminal, a smartphone and so forth, that is, computer devices which are adaptive to the inputting operation by the pen-shaped input device) which is connected together over a network which includes communication lines such as the Internet, a WAN, a LAN, and dedicated lines. In addition, “the computer-readable recording media” refers to portable media such as a flexible disc, a photomagnetic disc, a ROM, and a CD-ROM and storage devices such as an HDD, an SSD which are built in the computer system. The recording medium which stores the program in this way may be also a non-transitory recording medium such as the CD-ROM. In addition, also a recording medium which is installed on the inner side or the outer side which is accessible from a distribution server for distributing the program is included in the recording media. A code of a program which is stored into the recording medium of the distribution server may be different from a code of a program of the format which is executable by a terminal device. That is, as long as the program is of the type which is capable of being downloaded from the distribution server and being installed in the form of being executable by the terminal device, the format that the program is stored in the distribution server does not matter. Incidentally, configurations which are obtained by dividing one program into a plurality of programs, downloading the respective programs at mutually different timings and thereafter unifying the programs at the terminal device and distribution servers which distribute the respective programs which are so divided may be different from one another. Further “the computer readable recording media” shall also include the ones which hold the program for a definite period of time such as a server and a volatile memory (a RAM) which is installed in a computer system which serves as a client in a case where the program is transmitted over the network. In addition, the above-described program may be of the type which is adapted to realize some of the above-described functions. Further, the program may be of the type which is capable of realizing the above-described functions by combination with a program which has already been recorded in the computer system, that is, may be a so-called differential file (a differential program).

### DESCRIPTION OF SYMBOLS

100 information processing device
101 communication unit
102 touch panel display unit
103 control unit
104 storage unit
105 coordinates detection unit
121 display section
122 touch panel
131 application adaptive processing section
132 vibration control section
200 pen-shaped input device
201 communication unit
202 vibration unit
204 control unit
205 storage unit
241 driving control section
251 vibration waveform data storage section

What is claimed is:

1. An information processing system comprising:
a coordinates detector which is configured to detect coordinates which correspond to a position of an operational object surface with which a pen-shaped input device is in contact; and
a controller which is configured to so control as to switch ON/OFF of vibrations which are generated from the pen-shaped input device in accordance with an interval pattern which is obtained by sectionalizing a moving locus of the coordinates which are detected by the coordinates detector in a case where the pen-shaped input device moves in contact with the operational object surface in accordance with a predetermined distance.

2. The information processing system according to claim 1, wherein
the interval pattern corresponds to a broken-line pattern which is drawn in accordance with shifting of the coordinates which are detected.

3. An information processing system comprising:
a coordinates detector which is configured to detect coordinates which correspond to a position of an operational object surface with which a pen-shaped input device is in contact; and
a controller which is configured to make the pen-shaped input device generate first-order vibrations at a timing that a shifting state of the coordinates which are detected meets a predetermined condition in a case where the pen-shaped input device moves in contact with the operational object surface on the basis of a detection status of the coordinates which are detected by the coordinates detector.

4. The information processing system according to claim 3, wherein
the controller makes the pen-shaped input device generate the first-order vibrations in accordance with arrival of the coordinates which are detected by the coordinates detector at a boundary line of a predetermined pattern which is set on a coordinate surface which corresponds to the operational object surface.

5. The information processing device according to claim 4, wherein
the boundary line is set on the basis of the coordinates which are detected by the coordinates detector in a case where contact of the pen-shaped input device with the operational object surface is started.

6. The information processing system according to claim 3, wherein
in a case where the pen-shaped input device moves in contact with the operational object surface, the controller makes the pen-shaped input device generate the first-order vibrations in accordance with arrival of the coordinates which are detected by the coordinates detector at a point of a predetermined distance away from the point of the reference coordinates.

7. The information processing system according to claim 3, wherein
in a case where the pen-shaped input device moves in contact with the operational object surface, the controller makes the pen-shaped input device generate the first-order vibrations every time that the pen-shaped input device moves over a predetermined distance of the coordinates which are detected by the coordinates detector with a point of predetermined reference coordinates being set as a start point.

8. The information processing system according to claim 6, wherein
the reference coordinates are coordinates which are obtained in a case where contact of the pen-shaped input device with the operational object surface is started.

9. An information processing system comprising:
a coordinates detector which is configured to detect coordinates which correspond to a position of an operational object surface with which a pen-shaped input device is in contact; and
a controller which is configured to change the intensity of vibrations which are generated from the pen-shaped input device on the basis of a state of coordinates which are detected by the coordinates detector relative to predetermined reference coordinates in a case where the pen-shaped input device moves in contact with the operational object surface.

10. The information processing system according to claim 9, wherein
the controller changes the intensity of the vibrations which are generated from the pen-shaped input device in accordance with a distance of coordinates which are detected by the coordinates detector from the reference coordinates in a case where the pen-shaped input device moves in contact with the operational object surface.

11. The information processing system according to claim 9, wherein
the controller changes the intensity of the vibrations which are generated from the pen-shaped input device depending on whether a shifting direction of the coordinates which are detected by the coordinates detector in a case where the pen-shaped input device moves in contact with the operational object surface is either a direction that the coordinates are apart from the reference coordinates or a direction that the coordinates come close to the reference coordinates.

12. The information processing system according to claim 9, wherein
the reference coordinates are coordinates which are obtained in a case where contact of the pen-shaped input device with the operational object surface is started.
